(19) United States
(12) Patent Application Publication
(10) Pub. No.: US 2016/0125536 A1
(43) Pub. Date: May 5, 2016

(54) System and Method for Tracking Priority Interests in a Financial Trading System

(71) Applicants: Shelly Brown, West Windsor, NJ (US); Richard S. Ross, JR., Gladwyne, PA (US)

(72) Inventors: Shelly Brown, West Windsor, NJ (US); Richard S. Ross, JR., Gladwyne, PA (US)

(21) Appl. No.: 14/993,774

(22) Filed: Jan. 12, 2016

Related U.S. Application Data
(63) Continuation of application No. 14/046,530, filed on Oct. 4, 2013.
Application No. 14/046,530 is a division of application No. 13/689,408, filed on Nov. 29, 2012, now abandoned.
(60) Provisional application No. 61/663,675, filed on Jun. 25, 2012.

(51) Int. Cl. G06Q 40/04

(52) U.S. Cl. CPC G06Q 40/04

(57) ABSTRACT

An electronic trading platform can perform automated trading of one or more types of financial instruments (e.g., equities or options). Interests (e.g., quotes, set of quotes, bids and offers) of market participants are analyzed to determine if they qualify as a “Priority Interest” when an initiating interest is matched with resting interest on the contraside. If one or more interests qualify as a Priority Interest, the corresponding participant who submitted the corresponding interest may remain eligible for allocation in a Market Maker allocation tier. Allocation as a Market Maker with Priority Interest includes, but is not limited to, in combination or individually: (1) allocation ahead of or preference over other equal-priced interest, (2) Market Maker standard fees for trades corresponding to the interest, and/or (3) trades resulting from Priority Interest may count towards a Market Maker's volume requirement(s) in its appointed classes.

### CROSS-REFERENCE TO RELATED APPLICATION

This application is a continuation of U.S. patent application Ser. No. 14/046,530, entitled “System and Method for Tracking Priority Interests in a Financial Trading System,” filed Oct. 4, 2014, which is a divisional of U.S. patent application Ser. No. 13/689,408, entitled “System and Method for Tracking Priority Interests in a Financial Trading System,” filed Nov. 29, 2012, which claims priority to U.S. Prov. Patent No. 61/663,675, entitled “System and Method for Tracking Priority Interests in a Financial Trading System,” filed Jun. 25, 2012, wherein all of the aforementioned priority applications are hereby incorporated by reference in their entirety and for all purposes.

### FIELD OF INVENTION

The present invention is directed to a system and method for tracking interests in various financial instruments on an electronic trading system, and in one embodiment to an electronic trading platform including Priority Interests in various financial instruments on an electronic trading system.

### BACKGROUND OF THE INVENTION

A number of different electronic trading platforms enable buyers and sellers of various financial instruments (e.g., options and equities) to be matched according to a set of agreed upon trading rules. The Exchanges on which the trades are made may include rules on how trades are to be allocated under various conditions. For example, when a number of buyers all bid at the same price, the rules describe how many contracts each of the various buyers are allocated if there is an insufficient number of corresponding available sell contracts.

The rules on how many contracts in an order are allocated to each buyer (or seller) may also depend on the type(s) of buyers/sellers that are involved. For example, in addition to customers, there may also be non-customers (e.g., institutional investors and Market Makers). A Market Maker may receive a directed order and an associated Enhanced Allocation under certain circumstances in exchange for accepting the additional responsibilities of a particular level of Market Maker (e.g., quoting and participation requirements) and for meeting other financial requirements (e.g., having at least a threshold amount of capital).

### SUMMARY OF THE INVENTION

According to an example embodiment, a computerized trading platform may comprise a computer processor and digital computer memory including computer code stored therein. The computer code controls the computer processor to perform storing of respective resting interests from plural respective market participants; receiving from an initiating market participant an initiating contraside interest to the respective resting interests; determining what portion of the initiating contraside interest matches the respective resting interests; and determining how to allocate the matching interest among at least one of the plural respective market participants. The matching interest is allocated among the at least one of the plural respective market participants by determining if any of the matching interest qualifies as a Priority Interest; processing the interest that qualifies as a Priority Interest utilizing at least one allocation rule before the interest that does not qualify as a Priority Interest; and processing the interest that does not qualify as a Priority Interest utilizing the at least one allocation rule if any interest remains after processing the interest that qualifies as a Priority Interest.

According to another example embodiment, a computer-implemented method of trading performed by a computer processor controlled by computer code stored in a digital memory comprises storing of respective resting interests from plural respective market participants; receiving from an initiating market participant an initiating contraside interest to the respective resting interests; determining what portion of the initiating contraside interest matches the respective resting interests; and determining how to allocate the matching interest among at least one of the plural respective market participants. The matching interest is allocated among at least one of the plural respective market participants by determining if any of the matching interest qualifies as a Priority Interest; processing the interest that qualifies as a Priority Interest utilizing at least one allocation rule before the interest that does not qualify as a Priority Interest; and processing the interest that does not qualify as a Priority Interest utilizing the at least one allocation rule if any interest remains after processing the interest that qualifies as a Priority Interest.

According to still another example embodiment, the interest qualifies as a Priority Interest if the interest indicates that a difference between a bid and ask of the at least one of the plural respective market participants is less than or equal to a specified threshold.

According to an example embodiment, a non-transitory computer readable medium stores a computer program which when executed by a computer performs a method for ensuring fairness in allocation of contracts of a financial instrument to participants on an Exchange including a plurality of different allocation tiers. The method includes determining, by executing a match engine by the processor which accesses a shared memory storing interests of the participants, if interest of a participant in the financial instrument is a Priority Interest; assigning, by the match engine, the interest of the participant to one of the plurality of different allocation tiers based on whether the interest of the participant is a Priority Interest; and allocating, by the match engine, the contracts of the financial instrument to the participants in an order based on the plurality of different allocation tiers.

According to another example embodiment, a computerized trading platform includes a computer processor and digital computer memory including computer code stored therein. The computer code controls the computer processor to perform the steps of determining, by executing a match engine by the processor which accesses a shared memory storing interests of the participants, if interest of a participant in the financial instrument is Priority Interest; assigning, by the match engine, the interest of the participant to one of the plurality of different allocation tiers based on whether the interest of the participant is a Priority Interest; and allocating, by the match engine, the contracts of the financial instrument to the participants in an order based on the plurality of different allocation tiers.

### BRIEF DESCRIPTION OF THE DRAWINGS

The following description, given with respect to the attached drawings, may be better understood with reference to the non-limiting examples of the drawings, wherein:

FIG. 1 is a block diagram of an electronic trading platform for providing trading among a number of trading participants (e.g., customers, Market Makers and Lead Market Makers);

FIG. 2 is a flowchart showing processing of multiple trading participant interest at the same price in financial instruments according to one aspect of an exemplary trading platform; and

FIG. 3 is a flowchart showing processing of Market Maker interest in financial instruments according to one aspect of an exemplary trading platform.

### DISCUSSION OF THE PREFERRED EMBODIMENTS

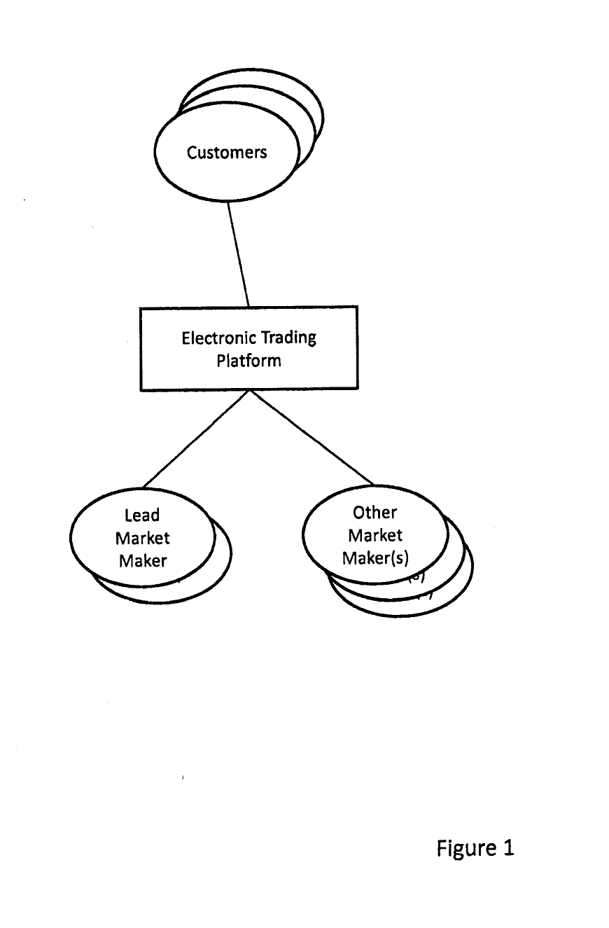

Turning to FIG. 1, an electronic trading platform is illustrated that facilitates trades between a number of possible trading parties. A trading platform can be implemented as a series of interconnected computers for communicating between the trading parties and a centralized computer system acting as the Exchange. The centralized computer system is preferably formed of at least one parallel processing computer that records the interactions between the trading parties and matches bids and offers as described more fully herein and in the attached Appendix. The computer system includes at least one computer processor, digital computer memory and nonvolatile storage devices (e.g., hard disk drives, disk arrays, and/or EEPROM/flash memory arrays). The computer system further includes computer code stored in the digital computer memory (potentially having been read from the non-volatile storage devices) for controlling the computer processor to perform steps defined by the computer code. The computer code controls the computer system to perform the processing described herein.

The electronic trading platform can perform trading of one or more types of financial instruments (e.g., equities or options). In one embodiment of the trading platform, incoming interests (e.g., quotes and orders) in a tradable financial instrument are analyzed to determine if there is a matching contraside interest (e.g., an initiating (i.e., incoming)) offer matching an existing (i.e., resting) bid or an initiating bid matching a resting offer for some number of contracts). If there are matching contraside interests, then the system will perform allocation of the interests according to exemplary rules described in greater detail below.

Interests in financial instruments are received by the electronic trading platform from a plurality of different sources and stored in shared memory. The electronic trading platform executes a match engine which accesses the shared memory to determine if a matching contraside interest been received by the shared memory. For example, if an initiating offer matching an existing bid or an initiating bid matching a resting offer for some number of contacts has been received by the shared memory. For example, the match engine may continuously poll shared memory locations for new or updated interests (e.g., in a round robin manner) and compare the new or updated interested with previously polled interests to determine matching interests. The match engine performs allocation of the interests according to exemplary rules described in greater detail below and reports out data on the interests received and the matches and allocations performed.

In one embodiment, Priority Quotes incentivize Market Makers to display a two-sided market considerably tighter than the Maximum Valid bid/ask spread width required by the rules of the Exchange. This tighter than required market is referred to as Priority Width on the Exchange. A Priority Width quote in and of itself does not provide a Market Maker with any special advantages. A Market Maker with interest which does not satisfy the defined Priority Width, however, is treated as a Professional Interest for the purposes of allocation and Exchange fees. A Market Maker with interest which does meet the defined Priority Width is eligible for the Market Maker allocation tier and may receive benefits including, but not limited to, in combination or individually: (1) allocation ahead of or preference over other equal-priced interest, (2) Market Maker standard fees for trades corresponding to the interest, and/or (3) trades resulting from Priority Interest may count towards a Market Maker's volume requirement(s) in its appointed class(es). A class may be defined as all options traded on the Exchange covering an underlying security. Market Makers with Priority Width quotes may also be eligible to receive an Enhanced Allocation when Primary Lead Market Maker (PLMM) or Directed Lead Market Maker (DLMM) overlays are in effect. Standards and obligations for qualification as the PLMM, the DLMM, Lead Market Makers (LMMs) and Registered Market Makers (RMMs) are defined in more detail in the Appendix attached hereto. According to one example embodiment, Priority Width requirements may affect allocations and/or fees for resting interests, but affect only fees for initiating interests.

When multiple participants with interest exist, the Exchange groups the participants into allocation tiers based on their participation type. For example, a first tier may include Priority Customer Orders, a second tier may include Priority Market Maker Quotes including all classes of Market Makers (allocated once all Priority Customer Orders at the same price have been executed in full) and a third tier may include all remaining Professional Orders and non-Priority Quotes (allocated once all Priority Customer Orders and Priority Quotes have been executed in full).

The Exchange applies price/time allocation or pro-rata allocation when an initiating order is matched against quotes and orders resting on the book. Price/time allocation and pro-rata allocation are independent and never co-exist in the same class. Allocation algorithms are configurable by class on the Exchange. The price/time allocation holds interests (quotes and orders) on the book in first-in-first-out (FIFO) order at each price level without regard to origin type, quote or order type, or priority status. Participants (e.g., customers, Market Makers and Lead Market Makers) may be allocated up to the full size of their bid or offer at a given price level for the price/time allocation.

For pro-rata allocation, at each price and priority/allocation level, participants are allocated contracts based on the relative sizes of their interests (except for in the Customer allocation tier, which is allocated by time, (e.g., FIFO)) as compared to the total market at that price and priority/allocation level. An Exchange Market Maker market participant identifier (MPID) identifies a particular Market Maker on the Exchange. All quotes (e.g., a standard quote and one or more eQuotes) for a particular Exchange Market Maker (MPID) at a given price level are aggregated into a single allocation unit and all non-Priority Quotes and orders for the particular Exchange Market Maker MPID are aggregated into a single allocation unit. Aggregated quotes and orders within the MPID allocation unit (priority level) are ranked for execution by time. Participants may only be allocated up to the full size of their bid or offer at a given price level for the pro-rata allocation, and allocations may always be rounded down to the nearest whole number of contracts. If there are two or more MPID's entitled to a fractional allocation within a priority level, each additional contract is distributed one at a time. Once an MPID has received one additional contract, distribution moves to the next entitled MPID in a “round robin” manner. The order of rotation is based on (i) size at the time the marketable interest arrived on the Exchange (prior to the first allocation for the transaction in question, and (ii) time. Fractional allocation may not be available to a Primary Lead Market Maker (PLMM) or a Directed Lead Market Maker (DLMM) who has received entitlements of 60% or 40% instead of pro-rata allocation. In one example embodiment, only Market Makers may be eligible to submit quotes to the Exchange, and all other participants must use orders.

For pro-rata allocation during auctions, all responses during auctions are capped at the aggregated original size of all interest on the side of the initiating quote or order including all quotes and orders received during the auction. Quotes and orders resting on the book at the time that the initiating quote or order arrived are not capped, unless changes are made during the auction period. Allocation caps do not apply at any time during the opening process during auctions.

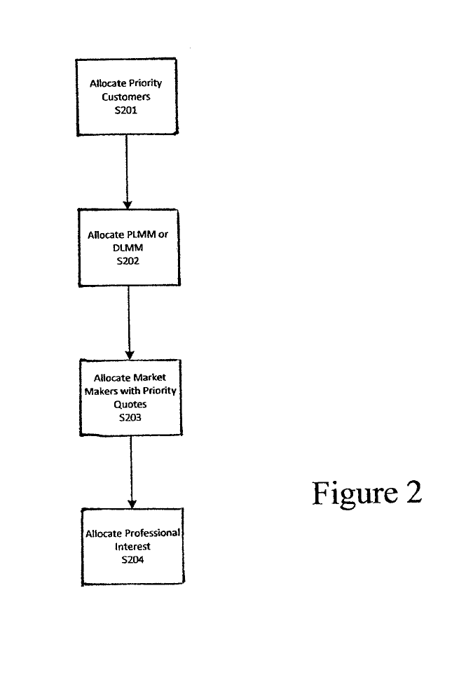

As shown in FIG. 2B, for pro-rata allocation at a given price level, Priority Customer Interest is executed before all other interest at step S201. Priority Customers with equal price levels are ranked by time. Priority Customer Interest is configurable by class. Market Maker interest with Priority Width quotes is executed after Priority Customer Interest.

Market Maker interest with Priority Width quotes may include a DLMM and/or a PLMM. DLMM and PLMM Enhanced Allocation entitlements are given priority after Priority Customers in the pro-rata allocation before other Market Makers with Priority Width Quotes at step S202. Priority Quotes, which are defined in more detail below, at the National Best Bid Offer (NBBO) are required for a DLMM or a PLMM to receive an Enhanced Allocation. Enhanced Allocation may only be made to a DLMM or a PLMM with a Priority Quote at the NBBO. DLMM and PLMM Enhanced Allocation may only be available when the Priority Customer Overlay, i.e., Priority Customers are given first priority, is applied to a given class. Enhanced Allocations apply when trading against marketable incoming orders and may be applied Exchange wide or configurable on or off by order origin type.

After any Enhanced Allocation entitlements are given, standard allocation resumes with RMM and non-directed LMMs with Priority Width quotes receiving allocations based on the allocation algorithm in effect for the class at step S203. If pro-rata allocation is in effect, RMM and non-directed LMM quoting is allocated after PLMM/DLMM Enhanced Allocation and applies only to Priority Quotes.

Professional Interest (Firm, B-D, MM orders and non-priority customer orders as well as non-priority MM quotes) uses the allocation algorithm in effect for the class after the RMM and non-directed LMM allocation with Priority Width quotes at step S204. If pro-rata, then Professional Interest is allocated after all LMM and RMM Priority Interest is exhausted. Each individual order and non-Priority Quote is allocated pro-rata. There is MPID aggregation. Allocation of remaining contracts after pro-rata rounding is performed using one-lot round robin by size and then by time.

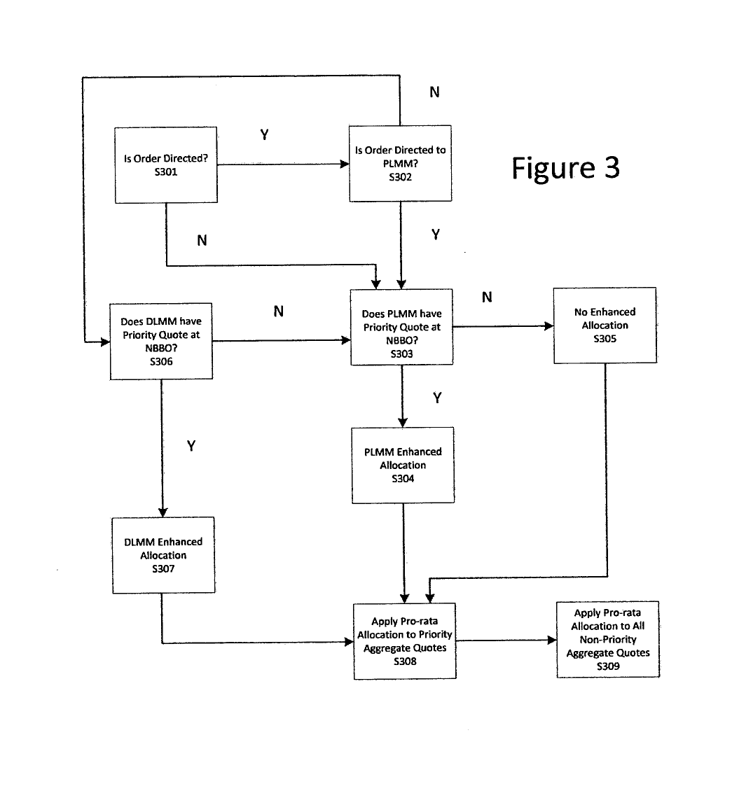

FIG. 3 is a flowchart showing processing of Market Maker interest in financial instruments according to one aspect of an exemplary trading platform. At step S301, it is determined whether an order is directed to a Lead Market Maker (LMM). If the order is directed to an LMM, then processing proceeds to step S302 which determines if the LMM is acting as the PLMM in the class. If the LMM is acting as the PLMM in the class, processing proceeds to step S303 to determine if the PLMM has a Priority Quote at the NBBO. If the PLMM has a Priority Quote at the NBBO, then the PLMM Enhanced Allocation applies to the PLMM in step S304. If on the other hand the PLMM does not have a Priority Quote at the NBBO at the time that the marketable order arrives, then no Enhanced Allocation applies to that order (S305). The PLMM Enhanced Allocation (described below) thus supersedes the DLMM Enhanced Allocation (described below) if the order is a directed order directed to the PLMM. That is, the entitlements that apply to the Primary Lead Market Maker supersede any entitlements applicable for that order under the Directed Order Program. If the a DLMM has a Priority Quote at the NBBO at the time of receipt of the incoming order and the DLMM is the PLMM, then the PLMM receives the PLMM Enhanced Allocation.

If, at step S302, it is determined that the order is directed to a LMM (i.e., a DLMM) that is not the PLMM in the class, processing proceeds to step S306 to determine if the DLMM has a Priority Quote at the NBBO at the time of receipt of the incoming order. If the DLMM has a Priority Quote at the NBBO at the time of receipt of the incoming order, the DLMM Enhanced Allocation applies to the DLMM in step S307.

If, at step S306, it is determined that the order is directed to a DLMM that is not quoting or that does not have a Priority Quote at the NBBO at the time of receipt of the incoming order, the DLMM is not entitled to any Enhanced Allocation and processing returns to step S303 to determine if the PLMM has a Priority Quote at the NBBO at the time of receipt of the order. The PLMM Enhanced Allocation (S304) is applied to the PLMM if the PLMM has a Priority Quote at the NBBO (S303). If the PLMM does not have a Priority Quote at the NBBO then the PLMM does not receive an Enhanced Allocation (S305). Allocation is pro-rata with all Market Makers with Priority Quotes receiving a pro-rata share of their Priority Interest (S308).

If the order is directed to a DLMM who is not assigned in the class or to an invalid Directed Firm Code (DFC), the order is treated as a non-directed order at step S301 and, if the PLMM has a Priority Quote at the NBBO at the time that the order arrived (S303), the PLMM is eligible for the PLMM Enhanced Allocation (S304). If the PLMM is also not present at the NBBO, then there is no Enhanced Allocation (S305).

If the order is not directed to a DLMM (no DFC) (S301) and the PLMM has a Priority Quote at the NBBO at the time that the order arrived (S303), the PLMM is eligible for the PLMM Enhanced Allocation (S304). If the order is not directed to a DLMM (no DFC) (S301) and the PLMM does not have a Priority Quote at the NBBO at the time that the order arrived (S303), there is no Enhanced Allocation (S305) and allocation is pro-rata with all Market Makers with Priority Quotes receiving a pro-rata share of their Priority Interest (S308).

After application of the DLMM and PLMM overlays, standard allocation resumes with RMM and non-directed LMMs with Priority Quotes receiving allocations based on the allocation algorithm in effect for the class (i.e., Pro-rata). RMM and non-directed LMMs with Priority Quotes are allocated after any PLMM/DLMM Enhanced Allocation at step S309.

During regular trading, DLMM Enhanced Allocation thus applies only (i) when the DLMM has a Priority Quote at the Exchange BBO (local BBO) and the Exchange BBO equals the NBBO, (ii) when the order is directed to the DLMM's DFC, (iii) when the eligible order is marketable upon arrival, (iv) to the balance remaining after any Priority Customers at better or equal prices have been satisfied, (v) to the balance remaining after any hidden liquidity at better prices has been satisfied, and (vi) if the order has not been directed to the PLMM. There is no DLMM Enhanced Allocation during the opening. During regular trading, if the DLMM has a Priority Quote which matches one other Market Maker (PLMM, LMM or RMM) with Priority Quotes, then the Enhanced Allocation is the greater of 60% or pro-rata. If the DLMM has a Priority Quote which matches two or more other Market Makers with Priority Quotes, the Enhanced Allocation is the greater of 40% or pro-rata. There is no DLMM small order preference. That is, the DLMM receiving the DLMM Enhanced Allocation does not receive 100% of an order unless no other Market Makers with Priority Quotes are quoting.

During regular trading, PLMM Enhanced Allocation thus applies only (i) when the PLMM has a Priority Quote at the Exchange BBO and the Exchange BBO equals the NBBO, (ii) when the eligible order is marketable upon arrival, (iii) to the balance remaining after any Priority Customers at better or equal prices have been satisfied, and (iv) to the balance remaining after any hidden liquidity at better prices has been satisfied. During the opening process, there is no PLMM Enhanced Allocation. There is no small order preference during the opening. During regular trading, if the PLMM has a Priority Quote which matches one other Market Maker (PLMM, LMM or RMM) with Priority Quotes, the Enhanced Allocation is the greater of 60% and pro-rata. If the PLMM has a Priority Quote which matches two or more other Market Makers with Priority Quotes, the PLMM Enhanced Allocation is the greater of 40% and pro-rata. Small size orders are orders with an original size of a predetermined number of contracts or fewer, e.g., 5 contracts or fewer. If the PLMM has a Priority Quote at the NBBO, the PLMM is entitled to a small size order preference, and the PLMM receives 100% of small sized orders regardless of how many other Market Makers are quoting. Accordingly, a difference between DLMM Enhanced Allocation and PLMM Enhanced Allocation according to an example embodiment is that there is no small order preference for DLMM Enhanced Allocation, whereas the PLMM receives 100% of small sized orders regardless of how many other Market Makers are quoting.

An allocation ahead of or preference over other equal-priced interest may include, in addition to or in place of the normal allocation rules applied by the Exchange, (1a) allocation ahead of or preference over equal-priced Non-Priority Market Maker Interest, (1b) allocation ahead of or preference over equal-priced Professional Interest, (1 c) allocation in the Market Maker tier (ahead of or preference over all other Professional interest) and/or (1d) allocation preference over time allocation. Alternatively, or in addition, allocation based on Priority Width requirements may be in the form of, either alone or in combination: trading ahead of equally priced interest, pro-rata allocation with a multiplier for enhancing allocation percentage, and carve-outs ahead of other Non-Priority Interest. If at any time a Market Maker's quotes fail to meet the Priority Width criteria, then quotations for that Market Maker are considered to be non-priority. Non-Priority Quotes (e.g., quotes not meeting the Priority Width criteria) are allocated in a lower allocation tier or non-priority fashion with other non-Priority Quotes and/or professional interests.

Alternatively, or in addition to allocation benefits over Professional Interests, a Market Maker may receive Market Maker standard fees for trades corresponding to the interest determined to have a Priority Interest. Such standard fees may be, for example, fees charged at the standard Market Maker rate or better (i.e., less). By comparison, interests having a non-Priority Interest may be charged another rate as defined by the Exchange.

Trades resulting from Priority Interest also may count towards a Market Maker's volume requirement(s) in its appointed class(es). Additionally, trades resulting from Non-Priority Interest may count towards the number of contracts executed during a quarter by a Market Maker in options classes to which it is not appointed.

To determine if an interest qualifies as a Priority Interest, which may be a requirement to be considered for allocation in the Market Maker allocation tier, at least one interest for a market participant (e.g., a Market Maker) is analyzed by the trading platform to determine if the at least one interest (or status) of the market participant meets one or more conditions of a set of Priority Interest rules. The electronic trading platform can support any kind of interest, including, but not limited to, orders, standard quotes and eQuotes as specified in the attached Rules Appendix, or any other liquidity types defined by the platform. Priority Width may be determined based on an option's recent average NBBO bid/ask spread, option price, option expiration term (e.g., days to expiration), and/or underlying security price. In one embodiment, one of the following conditions must exist to establish Priority Width quotes: (i) for orders that are marketable upon arrival, a Priority Width bid-to-offer differential must have existed at the time that the marketable order arrived; (ii) for quotes marketable on arrival, exclusive of that marketable new interest or update, the submitting Market Maker must have had a Priority Width bid-to-offer differential existing among their two-sided quotes resting on the book at the time that the marketable quote arrived; or (iii) for auctions and timers where the arriving order was not marketable on the Exchange at the time of arrival, a Market Maker must have a Priority Width bid-to-offer differential among their two-sided quotes resting on the book at the time of the inception of the auction or timer. The Priority Width value for each financial instrument traded on the Exchange may be disseminated to participants via data feeds of the electronic trading platform, e.g., upon the participants' initial connection for the trading session.

In one embodiment, the Exchange determines that the market participant has corresponding opposite interests such that an effective bid-ask spread of the market participant satisfies (e.g., is less than or equal to) a threshold specified by the Exchange/platform. In such an embodiment, the participant's interests must effectively be two-sided. That is, while a participant may not actually have a bid corresponding to an existing offer, the platform can treat the participant as having an effective $0.00 bid outstanding. Thus, the spread width is equal to the ask price when the market participant has an offer with no bid. However, for an interest where the participant has a bid but no offer, the bid may never be deemed to have a Priority Interest if the bid-ask spread is the only Priority Interest rule being applied. On the other hand, if a participant has a bid (but no offer) and then places an offer, the newly placed offer can then be used with the existing best bid to determine if the participant now has a bid-ask spread that satisfies the corresponding threshold.

Generally, the platform determines the best offer (ask) price for the participant (e.g., Market Maker) less the best bid price for the participant to determine the participant's bid-ask spread. The platform may use any kind of quotes (e.g., standard quotes, eQuotes and other quote types as may be defined by the Exchange) and may also include orders, at the discretion of the Exchange. The bid/ask spread (or width) may be measured at a number of different times, depending on the platform. For example, the spread may be measured (a) at the time the contraside (initiating) liquidity arrives, (b) at the time of the trade, (c) at Quote entry time, (d) at the time of the start of an auction or an event, (e) at the time the individual option is opened, or (f) at any other time as determined by the Exchange/platform.

The threshold or Priority Width, however, is preferably not greater than the maximum bid-ask spread defined in MIAX Exchange Rule 603(b)(4) found in the Appendix attached hereto, and may initially be set by the platform/Exchange to be Exchange-wide. However, various thresholds or Priority Widths can be used at various times and for various types of interests. For example, thresholds or Priority Widths may be set to different values for regular trading, for the opening process, for the reopening process and for certain auction or liquidity gathering events. For example, global tables may be set for penny, non-penny and special penny options, or tables for Priority Widths may be set class-by-class with custom tables for a particular class overriding the global tables. A table defines the spread width for each class. Alternatively, tables setting Priority Widths may be provided on an option-by-option basis with a custom table for a particular option overriding the global tables.

Furthermore, various thresholds for qualification as a Priority Quote may be set based on (1) expiration (term) of the option (e.g., may be different (or non-existent) for long term options), (2) option price (bid test or ask test), (3) an option class and/or for each option with a class, and (4) volume of the underlying options trading. In addition, the platform may use any one or a combination of the following inputs in determining the threshold value for each class and/or each option: (1) underlying price, (2) average underlying bid-ask spread, (3) underlying volatility, (4) underlying type (equity, ETF, Index, Currency, Commodity, future, etc.), and (5) average bid-ask spread for each option. The platform/Exchange also may use any one or a combination of the following information as at least part of its determination of the threshold for a given option: (1) the average bid-ask spread for an option as the base value calculated as an average over the course of some calculation time period, (2) the average spread/width plus an additive factor and (3) the average spread/width with a multiplicative function. In such configurations, the calculation time period can be at least any one of: a partial trading day, a full trading day, or a specified plurality of trading days (e.g., 5 trading days (1 calendar week), 10 trading days (2 calendar weeks), or 21 trading days (1 calendar month)).

In an example embodiment, the bid/ask spread for Priority Quotes may be as-wide-as the spread of the underlying security for “in-the-money” options. For calls, “in-the-money” means that the strike price of the option is less than the offer for the underlying security on its primary Exchange. For puts, “in-the-money” means that the strike price is greater than the bid for the underlying security on its primary trading Exchange. If at any time during the opening or regular trading day, the bid-to-offer spread on the primary trading Exchange for the underlying security is wider than the allowable bid-to-offer spread outlined in the applicable table (including any multipliers that may apply), quotes for options that are “in-the-money” may be considered Priority Width if the bid to offer spread does not differ by more than that of the underlying security.

When using an average spread/width plus an additive function, the platform may utilize a corresponding Minimum Price Variation (MPV) (sometimes referred to as a “tick”). For example, an option with an MPV of $0.05 may have an average spread of $0.085 and the test may require an additive value of 2 MPVs. In such a case, the Priority Interest may be defined as having a quote spread of at most $0.185=($0.085+(2×$0.05)).

Similarly, when using an average width with a multiplicative function, a multiplier is defined such that, for example, an average spread for a given option is $0.085 and the multiplier is 2.5. As a result, the Priority Interest may be defined as having a quote spread of at most $0.2125=($0.085×2.5). Multipliers may be applied to spreads for tables on a class-by-class or global basis for opening and regular trading. A multiplier may preferably be between 0.1 and 5.0 inclusive.

Priority Width (PW) or quote spread for a Priority Interest may by way of example be defined by the following equation (1):

$$P W = ( \frac{H S + or * x}{M P V} ) ↑ + y \qquad ( 1 )$$

wherein HS is a historical spread of quotes for the financial instrument, wherein HS is one of added to or multiplied by a first multiplier x and then divided by a MPV of the instrument to achieve a numerical result. The numerical result inside the bracket is then raised/rounded up to the nearest whole tick or MPV of the financial instrument. A variable y may be added to the raised result.

Priority Width (PW) or quote spread for a Priority Interest may by way of example be defined by the following equation (2):

$$P W = ( \frac{H S + or * x}{M P V} ) ↑ ↓ + y \qquad ( 2 )$$

wherein HS is a historical spread of quotes for the financial instrument, wherein HS is one of added to or multiplied by a first multiplier x and then divided by a MPV of the instrument to achieve a numerical result. The numerical result inside the bracket is then rounded up or down to the nearest whole tick or MPV of the financial instrument. A variable y may be added to the rounded result.

Priority Width (PW) or quote spread for a Priority Interest may by way of example be defined by the following equation (3):

PW=(HS+or*x)↑+y (3)

wherein HS is a historical spread of quotes for the financial instrument, wherein HS is one of added to or multiplied by a first multiplier x. The numerical result inside the bracket is then raised/rounded up to the nearest whole tick or MPV of the financial instrument. A variable y may be added to the raised result.

Priority Width (PW) or quote spread for a Priority Interest may by way of example be defined by the following equation (4):

PW=(HS+or*x)↑↓+y (4)

wherein HS is a historical spread of quotes for the financial instrument, wherein HS is one of added to or multiplied by a first multiplier x. The numerical result inside the bracket is then rounded up or down to the nearest whole tick or MPV of the financial instrument. A variable y may be added to the rounded result.

The HS of the quotes of the financial instrument may for example be based on any desired percentage of quotes for that instrument for any desired number of prior trading days or portions thereof. Thus, the HS may be the average spread width or average weighted spread width over a predetermined number of prior trading days or portions thereof. For example, the spread width may be calculated based on the last 3 days with day 1 being weighted at 50%, day 2 being weighed at 30% and day 3 weighted at 20%. The PW may be determined based on the history of quotes so that the number of days used to determine the HS and/or the multiplier is adjusted if a change in the quote spread over a predetermined number of prior trading days violates a threshold.

After the PW for a Priority Interest is set for a trading day, the PW does not change except in the case of an override. If the NBBO for the Priority Interest is wider than the PW at some time during regular trading, an automatic override may occur which resets the PW for the Priority Interest to the NBBO or a predetermined value. For at least one interest to be treated as having a Priority Interest, the Exchange may require, in addition to or in place of, the spread/width test, either individually or in any combination thereof, at least one other Priority Interest test (e.g., a Best Bid Offer (BBO) test, a size test, a current market performance test and/or a historic market test), as described below in greater detail.

According to a BBO test (of the exemplary Priority Interest tests), in order to qualify for Priority Interest, an interest may be required to: improve the National BBO (NBBO) for at least one of the bid and the ask; match the NBBO for at least one of the bid and the ask; improve the local Exchange BBO for at least one of the bid and the ask; match the local Exchange BBO for at least one of the bid and the ask; be within a defined number of ticks (MPVs) of the NBBO for at least one of the bid and the ask; and be within a defined number of ticks (MPVs) of the local Exchange BBO for at least one of the bid and the ask. The BBO test may be performed instantaneously, e.g., the BBO at the time of the receipt of the quote may be determined, or the BBO historically over one or more trading days or portions thereof may be determined. The BBO test may be applied to individual options, a subset of options within the class (e.g., having the same month, similar strike price, etc.), or the entire class.

According to a size test (of the exemplary Priority Interest tests), in order to qualify for Priority Interest, a size of the corresponding interest(s) may be required to meet (for at least one side of the interest) a defined minimum quote, eQuote, order or combined (same price) size. The size of the corresponding interest(s) is the number of contracts being bid and/or offered in the quote, eQuote or order, or the combination of all eligible interest at the market participant's best price. The size may be defined as the minimum quote size defined by the Exchange or may be some other minimum size value as set by the Exchange (e.g., Exchange-wide, class-by-class, or option-by-option). The platform may also support that the minimum size values may be different at different times (e.g., during regular trading, during the opening process, or during certain auction or liquidity gathering events).

According to an exemplary current market performance test (of the exemplary Priority Interest tests), in order to qualify for Priority Interest, a market participant (e.g., Market Maker) may be required to have (or to have had) Priority Interest present in the class (using one of the other Priority Interest tests) for some minimum percentage of options in the class at the time of Priority Interest evaluation. For example, a minimum of 60% of all of the market participant's quotes in options for a hypothetical “XYZ” class of options must be within other Priority Interest defined parameters for any of its quotes to be Priority Interest in the class.

According to an exemplary historic market performance test (of the exemplary Priority Interest tests), in order to qualify for Priority Interest, a market participant (e.g., Market Maker) may be required to have had Priority Interest present in the class (using one of the other Priority Interest tests) for some minimum percentage of options in the class for some minimum period (or percentage of time over a predefined prior quoting period). For example, a minimum of 60% of all of the market participant's quotes in options for a hypothetical “XYZ” class of options must have been within other Priority Interest defined parameters for the prior 21 trading days for any of its quotes to be Priority Interest in the class.

According to another exemplary historic market performance test (of the exemplary Priority Interest tests), in order to qualify for a Priority Interest, a market participant (e.g., Market Maker) may be required to have traded or to be trading at a certain volume for a predetermined time (historical or not). The required volume may be determined in various manners, for example by determining a percentage volume at which the market participant has traded or is trading at on the Exchange, or a percentage volume at a class or individual option level (e.g., Market Maker volume at the Exchange, etc.).

As described above, Priority Interest need not be limited to Market Makers, i.e., to qualification for the Market Maker allocation tier. Instead, the Exchange/platform may require Exchange Membership types other than Market Makers to qualify for Priority Interest. In such an embodiment, Priority Interest may apply within allocation tiers or across allocation tiers. Priority Interest also may apply to orders from Electronic Exchange Members (EEMs) for orders and/or may be defined by origin code (e.g., Customer, Professional Customer, Firm, Broker Dealer, and Non-Priority Market Maker Interest).

Each Priority Interest eligibility test (or tests) may be measured/determined: (1) at the time the contra side (initiating) liquidity arrives (but not with respect to an auction or event responses used in the calculation), (2) at the time of the trade, (3) at Quote entry time, (4) at a time of the start of an auction or an event, (5) at the time the individual option is opened, or (6) at any other time as determined by the Exchange.

In addition to the embodiments explicitly described above, it should be understood that any number of the Priority Interest rules can be used together. For example, if an interest satisfies a corresponding size test and is within a specified threshold of the NBBO (which is larger than the threshold used without also meeting a second test), then the interest of a market participant may still qualify for Priority Interest even though the market participant's bid/ask spread is larger than the threshold used without also meeting the size test. As an example, one can assume a first bid/ask threshold for a particular option is set to be an average spread plus 2 MPV if only the bid/ask threshold test is to be met. However, one can assume a second bid/ask threshold for the same option is to be set to be an average spread plus 4 MPV if the bid/ask threshold test is to be met and the market participant also meets a current market performance test. A platform may utilize any number of levels/layers of thresholds without departing from the teachings of the present invention.

While certain configurations of structures have been illustrated for the purposes of presenting the basic structures of the present invention, one of ordinary skill in the art will appreciate that other variations are possible which would still fall within the scope of the appended claims.

1. A computerized trading platform, comprising:
a computer processor;
digital computer memory including computer code stored therein, the computer code controlling the computer processor to perform the steps of:
storing, in a shared memory, respective resting interests from plural respective market participants;
receiving from an initiating market participant, by executing a match engine by the computer processor which accesses the shared memory, an initiating contraside interest to the respective resting interests;
determining, by the match engine, what portion of the initiating contraside interest matches the respective resting interests; and
determining, by the match engine, how to allocate the matching interest among at least one of the plural respective market participants by:
determining, by the match engine, if any of the matching interest qualifies as a Priority Interest;
processing, by the match engine, the interest that qualifies as a Priority Interest utilizing at least one allocation rule before the interest that does not qualify as a Priority Interest; and
processing, by the match engine, the interest that does not qualify as a Priority Interest utilizing the at least one allocation rule if any interest remains after processing the interest that qualifies as a Priority Interest.

2. The computerized trading platform as claimed in claim 1, wherein the interest qualifies as a Priority Interest if the interest indicates that a difference between a bid and ask of the at least one of the plural respective market participants satisfies a specified threshold.

3. The computerized trading platform as claimed in claim 2, wherein the market participant comprises a Market Maker.

4. The computerized trading platform as claimed in claim 3, wherein the bid and ask of the Market Maker are a bid and an ask utilizing at least one of a standard quote and an eQuote.

5. The computerized trading platform as claimed in claim 1, wherein the processing the interest that qualifies as a Priority Interest further comprises utilizing a Priority Interest allocation rule.

6. The computerized trading platform as claimed in claim 1, wherein the processing the interest that qualifies as a Priority Interest further comprises utilizing a Priority Interest fee rule.

7. The computerized trading platform as claimed in claim 1, wherein the processing the interest that qualifies as a Priority Interest further comprises a utilizing Priority Interest volume rule.

8. The computerized trading platform as claimed in claim 1, wherein the interest qualifies as a Priority Interest if the interest indicates that a difference between a bid and ask of the at least one of the plural respective market participants satisfies a specified threshold and at least one interest of the at least one of the plural respective market participants satisfies a second Priority Interest test.

9. The computerized trading platform as claimed in claim 8, wherein the second Priority Interest test comprises a Best Bid Offer test.

10. The computerized trading platform as claimed in claim 8, wherein the second Priority Interest test comprises a size test.

11. The computerized trading platform as claimed in claim 8, wherein the second Priority Interest test comprises a current market performance test.

12. The computerized trading platform as claimed in claim 8, wherein the second Priority Interest test comprises a historic market performance test.

13. A computer-implemented method of trading performed by computer processor controlled by computer code stored in a digital memory, the method comprising the steps of:
storing, in a shared memory, respective resting interests from plural respective market participants;
receiving from an initiating market participant, by executing a match engine by the computer processor which accesses the shared memory, an initiating contraside interest to the respective resting interests;
determining, by the match engine, what portion of the initiating contraside interest matches the respective resting interests; and
determining, by the match engine, how to allocate the matching interest among at least one of the plural respective market participants by:
determining, by the match engine, if any of the matching interest qualifies as a Priority Interest;
processing, by the match engine, the interest that qualifies as a Priority Interest utilizing at least one allocation rule before the interest that does not qualify as a Priority Interest; and
processing, by the match engine, the interest that does not qualify as a Priority Interest utilizing the at least one allocation rule if any interest remains after processing the interest that qualifies as a Priority Interest.

14. The method as claimed in claim 13, wherein the interest qualifies as a Priority Interest if the interest indicates that a difference between a bid and ask of the at least one of the plural respective market participants satisfies a specified threshold.

15. The method as claimed in claim 13, wherein the interest qualifies as a Priority Interest if the interest indicates that a difference between a bid and ask of the at least one of the plural respective market participants satisfies a specified threshold and at least one interest of the at least one of the plural respective market participants satisfies a second Priority Interest test.
